(19) United States
(12) Patent Application Publication
(10) Pub. No.: US 2008/0143107 A1
(43) Pub. Date: Jun. 19, 2008

(54) FLUID INTERCONNECT ASSEMBLY

(76) Inventors: Bruce A. Bowling, Beavercreek, OH (US); Timothy T. Hare, West Carollton, OH (US); James A. Katerberg, Kettering, OH (US)

Correspondence Address: David A. Novais;Patent Legal Staff, Eastman Kodak Company, 343 State Street, Rochester, NY, 14650-2201, US

(21) Appl. No.: 11/609,940

(22) Filed: Dec. 13, 2006

(51) Int. Cl. F16L 25/00

(52) U.S. Cl. 285/334.5

(57) ABSTRACT

A connector includes a structure for receiving the tubing and a mechanism for releasably retaining the tubing over the tubing receiving structure. The structure for receiving the tubing includes an exterior surface with portions of the exterior surface of the structure defining a tapered section and at least one ring. The mechanism for releasably retaining the tubing over the tubing receiving structure is releasably engagable with the tubing receiving structure. Portions of the mechanism define a longitudinal bore through which the tubing can be inserted. The mechanism includes an interior surface with portions of the interior surface defining a tapered section. When the tubing is positioned over the tapered section and the at least one ring of the tubing receiving structure and the tubing receiving structure is engaged with the retaining mechanism, at least two fluid seals are created or present. A first fluid seal is present between the tapered section of the tubing receiving structure, the tubing, and the tapered section of the retaining mechanism. A second fluid seal is present between the tubing and the at least one ring of the tubing receiving structure.

### FIELD OF THE INVENTION

The present invention relates generally to fittings for connecting tubing to a secondary structure, and in particular to fittings that releasably retain the tubing to the secondary structure without permanently deforming the tubing.

### BACKGROUND OF THE INVENTION

Fittings for connecting tubing are known. One popular model of a tube fitting is the Ultrapure Flare Style by Flaretek® for use with several plumbing applications where purified water or chemicals are being distributed. This particular tube fitting is used in conjunction with a flaring tool and heat resulting in a semi-permanent to permanent deformation of the tubing through the creation of a sharp edge and flared end on the tubing. Watertight connection seal is made and maintained by creating a pinch point at this sharp edge between the fitting body and a tube nut.

U.S. Pat. No. 6,412,832 describes a self-flaring plastic fitting in which a flare tool and heat are not necessary. However, the particular fitting includes a tapered end and a fitting nut having at least one annular groove engaging portion such that as when the fitting nut is tightened the tube will self-flare. This annular groove engaging portion is commonly known within the art as a ‘barb.’

Accordingly, there is a need to be able to connect tubing to a secondary structure with permanently deforming the tubing thereby allowing the tubing to be connected and disconnected multiple times.

### SUMMARY OF THE INVENTION

According to one aspect of the present invention, a connector for coupling tubing includes a structure for receiving the tubing and a mechanism for releasably retaining the tubing over the tubing receiving structure. The structure for receiving the tubing includes an exterior surface with portions of the exterior surface of the structure defining a tapered section and at least one ring. Portions of the mechanism for releasably retaining the tubing over the tubing receiving structure define a longitudinal bore through which the tubing can be inserted. The retaining mechanism includes an interior surface with portions of the interior surface defining a tapered section.

When the tubing is positioned over the tapered section and the at least one ring of the tubing receiving structure and the tubing receiving structure is engaged with the retaining mechanism fluids seals are created or present. A first fluid seal is present between the tapered section of the tubing receiving structure, the tubing, and the tapered section of the retaining mechanism. A second fluid seal is present between the tubing and the at least one ring of the tubing receiving structure.

According to another aspect of the present invention, a connector for coupling tubing to another structure includes a structure for receiving the tubing and a mechanism for releasably retaining the tubing over the tubing receiving structure. The structure for receiving the tubing includes an exterior surface with portions of the exterior surface of the structure defining a tapered section, a threaded section, and at least one ring located between the threaded section and the tapered section. Portions of the mechanism for releasably retaining the tubing over the tubing receiving structure define a longitudinal bore through which the tubing can be inserted. The mechanism includes an interior surface with portions of the interior surface defining a tapered section and a threaded section.

When the tubing is positioned over the tapered section and the at least one ring of the tubing receiving structure and the threaded section of the tubing receiving structure is engaged with the threaded section of the retaining mechanism fluid seal are created or present. A first fluid seal is present between the tapered section of the tubing receiving structure, the tubing, and the tapered section of the retaining mechanism. A second fluid seal is present between the tubing and the at least one ring of the tubing receiving structure.

### BRIEF DESCRIPTION OF THE DRAWINGS

In the detailed description of the preferred embodiments of the invention presented below, reference is made to the accompanying drawings, in which:

FIG. 1 is a schematic a cross sectional view illustrating an example embodiment made in accordance with the present invention showing a structure for receiving the tubing unengaged with a mechanism for releasably retaining the tubing;

FIG. 2 is a schematic a cross sectional view illustrating the example embodiment showing the structure for receiving the tubing engaged with the mechanism for releasably retaining the tubing;

FIGS. 3A and 3B are enlarged schematic a cross sectional views showing portions of the structure for receiving the tubing and the mechanism for releasably retaining the tubing;

FIGS. 3C, 3D, and 3E are schematic a cross sectional views illustrating alternative example embodiments made in accordance with the present invention;

FIGS. 4A and 4B are schematic a cross sectional views illustrating another alternative example embodiment made in accordance with the present invention; and

FIG. 5 is a schematic cross sectional view illustrating another alternative embodiment made in accordance with the present invention.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

The present invention includes a connector, often referred to as a fitting for coupling or connecting tubing to a secondary structure and releasably retaining the tubing to the secondary structure. The connector includes a structure for receiving the tubing and a mechanism for releasably retaining the tubing over the tubing receiving structure.

The structure for receiving the tubing includes an exterior surface with portions of the exterior surface of the structure defining a tapered section and at least one ring. The mechanism for releasably retaining the tubing over the tubing receiving structure is releasably engagable with the tubing receiving structure. Portions of the mechanism define a longitudinal bore through which the tubing can be inserted. The mechanism includes an interior surface with portions of the interior surface defining a tapered section.

When the tubing is positioned over the tapered section and the at least one ring of the tubing receiving structure and the tubing receiving structure is engaged with the retaining mechanism, at least two fluid seals are created or present. A first fluid seal is present between the tapered section of the tubing receiving structure, the tubing, and the tapered section of the retaining mechanism. A second fluid seal is present between the tubing and the at least one ring of the tubing receiving structure.

The retaining mechanism of the connector includes structure, for example, threads, a clamp, a retaining ring, a pin, etc. so that the retaining mechanism is releasably engagable with the tubing receiving structure. The tubing receiving structure includes the appropriate complementary structure so that the retaining mechanism is releasably engagable with the tubing receiving structure.

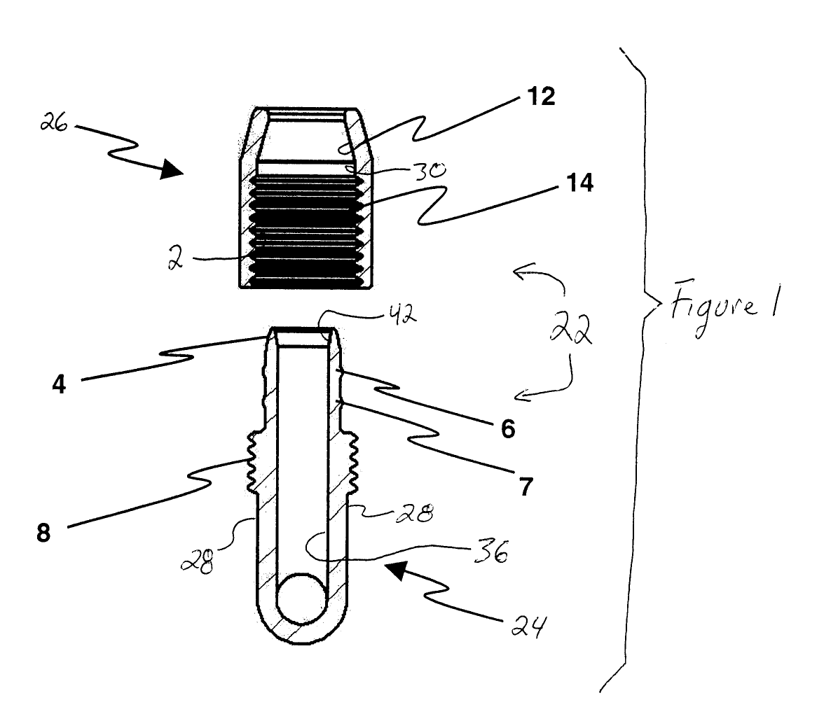

Example embodiments of the present invention will now be described with reference to FIGS. 1-5.

Referring to FIG. 1, an example embodiment made in accordance with the present invention is shown. Connector 22 includes a structure for receiving tubing 24 and a mechanism 26 for releasably retaining tubing over tubing receiving structure 24.

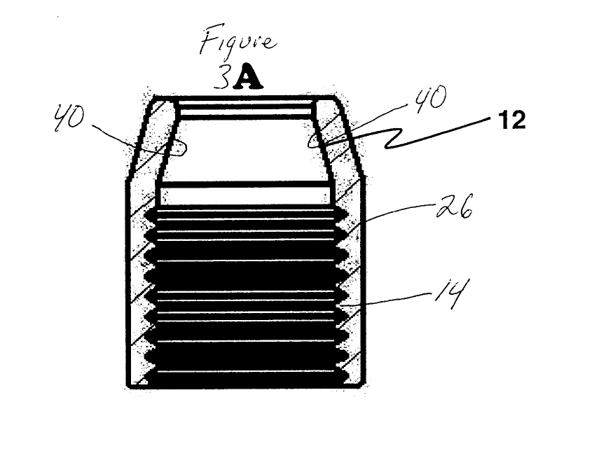

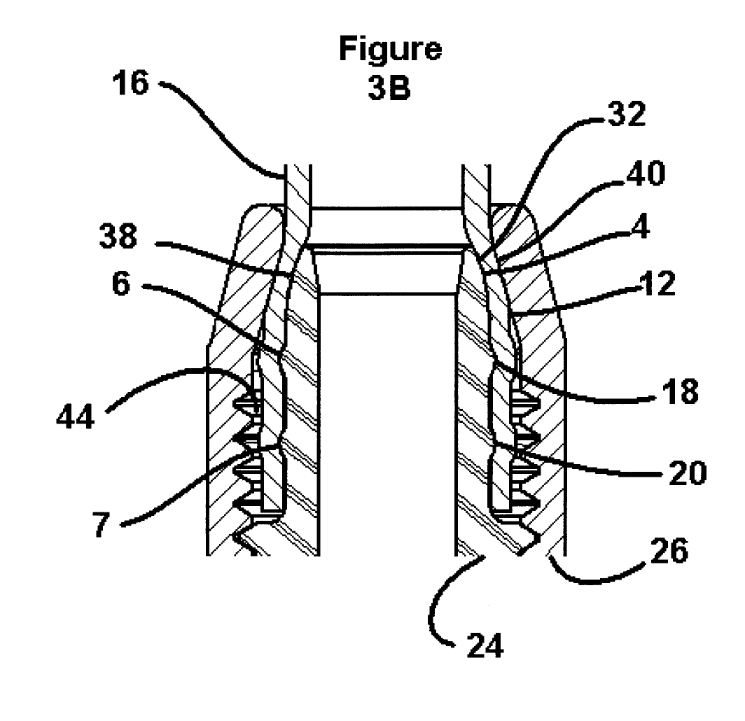

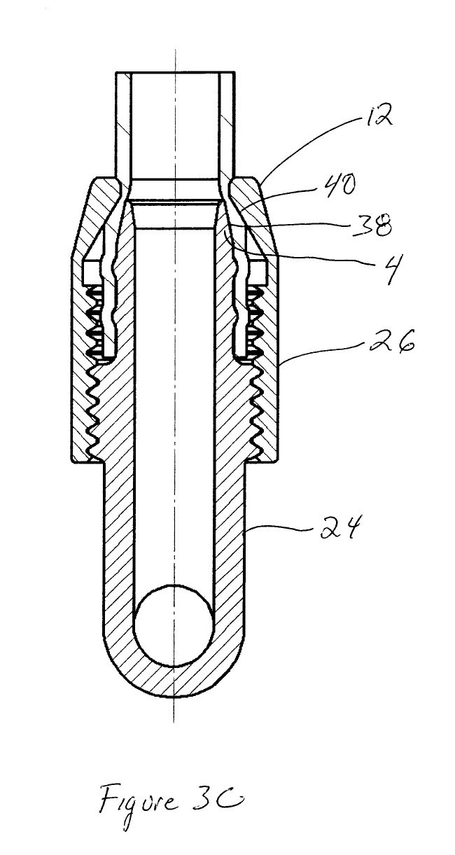

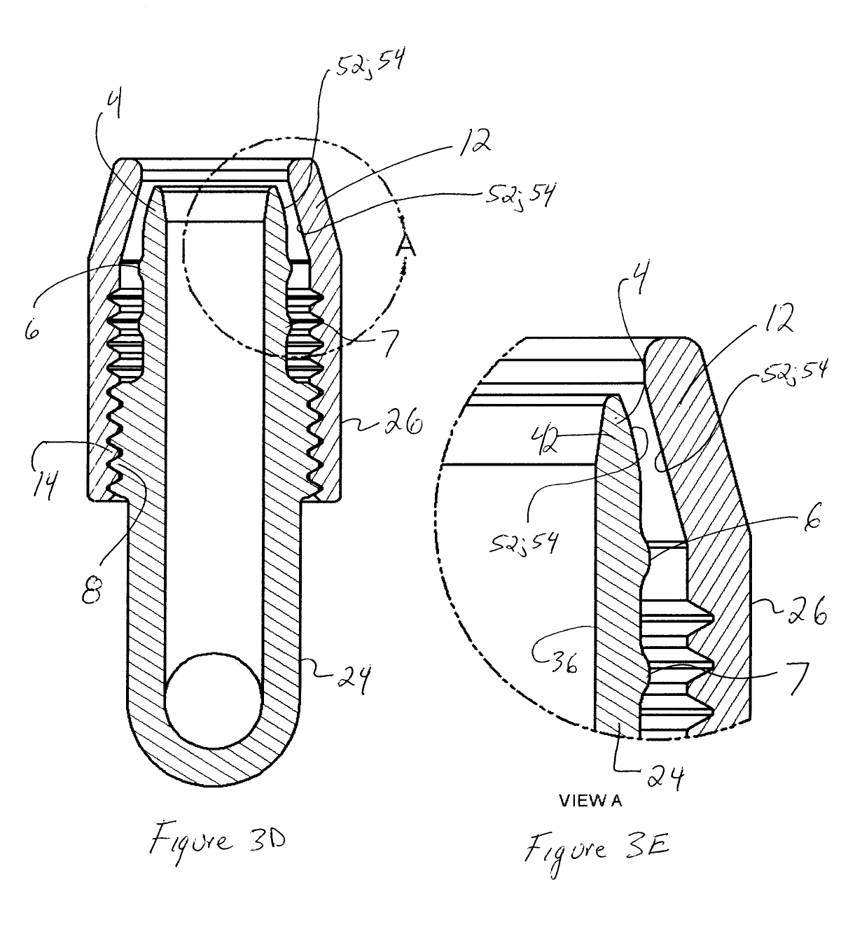

Tubing receiving structure 24 includes an exterior surface 28 with portions of exterior surface 28 defining a tapered section 4, a threaded section 8, and at least one ring 6, 7 located between threaded section 8 and tapered section 4. Tubing receiving structure 24 can include a longitudinal bore 36 through which fluid can pass. Longitudinal bore 36 can include a tapered section 42 (shown in FIG. 3E) that extends in a direction that is substantially opposite that of the direction in which tapered section 4 of tubing receiving structure 24. Alternatively, tubing receiving structure 24 can be made without a longitudinal bore 36. In this configuration, receiving structure 24 can be used as a removable cap to seal off the end of tubing 16.

Portions of retaining mechanism 26 define a longitudinal bore 2 through which tubing can be inserted. Mechanism 26 includes an interior surface 30 with portions of interior surface 30 defining a tapered section 12 and a threaded section 14.

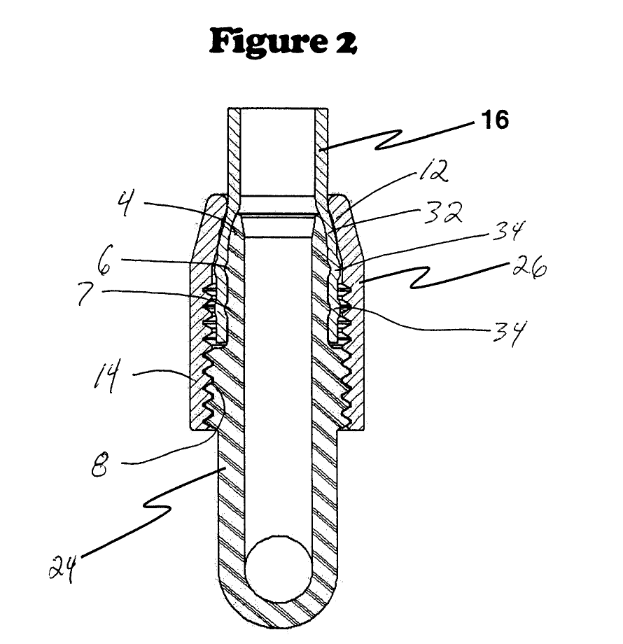

Referring to FIG. 2, tubing 16 has been inserted through longitudinal bore 2 of mechanism 26. When tubing 16 is positioned over tapered section 4 and the at least one ring 6, 7 of tubing receiving structure 24 and threaded section 8 of tubing receiving structure 24 is engaged with threaded section 14 of retaining mechanism 26, at least two fluid seals are created or present. A first fluid seal 32 is present between tapered section 4 of tubing receiving structure 24, tubing 16, and tapered section 12 of retaining mechanism 26 and a second fluid seal 34 is present between tubing 16 and the at least one ring 6, 7 of tubing receiving structure 24.

Fluid seals 32 and 34 are maintained by the engagement of threaded section 8 of tubing receiving structure 24 with threaded section 14 of retaining mechanism 26. Tubing 16 is also releasably retained by the engagement of threaded section 8 of tubing receiving structure 24 with threaded section 14 of retaining mechanism 26.

Referring to FIGS. 3A and 3B, when viewed in cross section, tapered section 4 of tubing receiving structure 24 and tapered section 12 of retaining mechanism 26 extend in the same direction when compare to each other so that first fluid seal 32 is created with tubing 16 between tapered section 4 of tubing receiving structure 24 and tapered section 12 of retaining mechanism 26. The taper angle 38 of tapered section 4 of tubing receiving structure 24 can be substantially equivalent when compared to the taper angle 40 of tapered section 12 of retaining mechanism 26. However, and referring to FIG. 3C, the taper angle 38 of tapered section 4 of tubing receiving structure 24 can be different when compared to the taper angle 40 of tapered section 12 of retaining mechanism 26.

Referring to FIGS. 3D and 3E, tapered section 4 and tapered section 12 can have several shapes when viewed in cross section. For example, one or both of tapered section 4 and tapered section 12 can include a toroidal or curved portion 52. Alternatively, one or both of tapered section 4 and tapered section 12 can include a conical, straight, or linear portion 54.

The presence of tapered section 4 helps to eliminate the need for tube flaring devices often used in conjunction with prior art fittings. This is advantageous because flaring devices can permanently deform tubing 16 reducing its useful life. In the present invention, tubing 16 is left virtually unaffected when first fluid seal 32 is created.

The presence of taper section 12 of retaining mechanism 26 helps to gradually urge tubing 16 over tapered section 4 of tubing receiving structure 24 without permanently deforming tubing 16 and helps to increase the area over which first fluid seal 32 is formed. This is advantageous when compared to prior art fittings, especially prior art fittings that use tube flaring devices, because prior art fittings use the tube flaring device to create a pinch point type of fluid seal at the point of tube flare. Instead, first fluid seal 32 of the present invention is distributed substantially along the entire portion of tapered sections 4 and/or tapered section 12

Referring back to FIG. 3B, second fluid seal 34 is shown in more detail. Second fluid seal 34 helps to provide redundant fluid sealing in the event first fluid seal 32 begins to leak or fail. Rings 6 and 7 create second fluid seal 34 with tubing 16 forming redundant second fluid seals 34 (shown using reference signs 18 and 20). This is true even though a gap 44 may exist between interior surface 30 of retaining mechanism 26 and tubing 16 after tubing 16 has been positioned over tapered section 4 and at least one ring 6, 7 of tubing receiving structure 24 and threaded section 8 of tubing receiving structure 24 has been engaged with threaded section 14 of retaining mechanism 26. Tubing 16 is not permanently deformed when urged over rings 6, 7. As such, tubing 16 can be removed and reapplied to tubing receiving structure 24 without this process causing detrimental structural changes to tubing.

Additional second fluid seals 34 can be provided on connector 22 if desired. In FIG. 3B, the presence of rings 6 and 7 helps to create two of second fluid seals 34. More of second fluid seals 34 can be created by forming more rings 6, 7 while fewer second fluid seals 34 can be created by forming less rings 6, 7. Although described as rings 6, 7, other shapes can be used to create second fluid seals 34.

Connector 22 can be fabricated from various materials depending on the specific application contemplated. For example, tubing receiving structure 24 and/or retaining mechanism 26 can be made from a plastic material or a metal material, for example, a high purity metal such as stainless steel, titanium, etc., using a molding process.

All or portions of connector 22 can be polished. For example, portions of the exterior surface 28 of tubing receiving structure 24 and/or portions of the interior surface 30 of retaining mechanism 26 contactable with tubing 16 can be polished. When tubing receiving structure 24 and/or retaining mechanism 26 is made from a plastic material, vapor polishing of regions contactable with tubing 16 help to remove flash or part line discontinuity from mold halves thereby reducing the likelihood of tearing and/or permanently deforming tubing 16. When tubing receiving structure 24 and/or retaining mechanism 26 is made from a metal material, electropolishing techniques can be used. As such, the present invention provided for a cleaner environment for fluid connection as compared to prior art fittings. By reducing the likelihood of the presence of barbs and/or extreme tube flaring, the likelihood of small pieces of tubing breaking off and contaminating fluid are also reduced.

Tubing 16 can be made from various types of material, for example, PE, PP, PFA, PTFE, FEP, LLDPE, etc. The present inventions is advantaged over prior art fittings in that connector 22 can be used with thin wall tubing, for example, tubing having a wall thickness ranging between 0.010 and 0.050 inches. Thin wall tubing typically could not be used with many prior art fittings because many prior art fittings required the use of a flaring device to create the fluid seal. Tapered section 12 and/or tapered section 4 help in the creation of first fluid seal 32 even when thin wall tubing is used with connector 22.

First fluid seal 32 and second fluid seal 34 of connector 22 as described herein have been demonstrated to satisfactorily perform, with connector 22 being only hand tightened, at room temperature and elevated temperature and at pressures ranging from 100 to 300 PSI. This makes connector 22 suitable for use in typical inkjet environments as well as other applications. When used in an inkjet environment, connector 22 can be used, for example, to connect a fluid storage tank(s) to a printhead(s); a fluid supply and/or return line(s) to fluid storage tanks and/or printheads; etc. Connector 22 also does not require special tools for connection and/or disconnection.

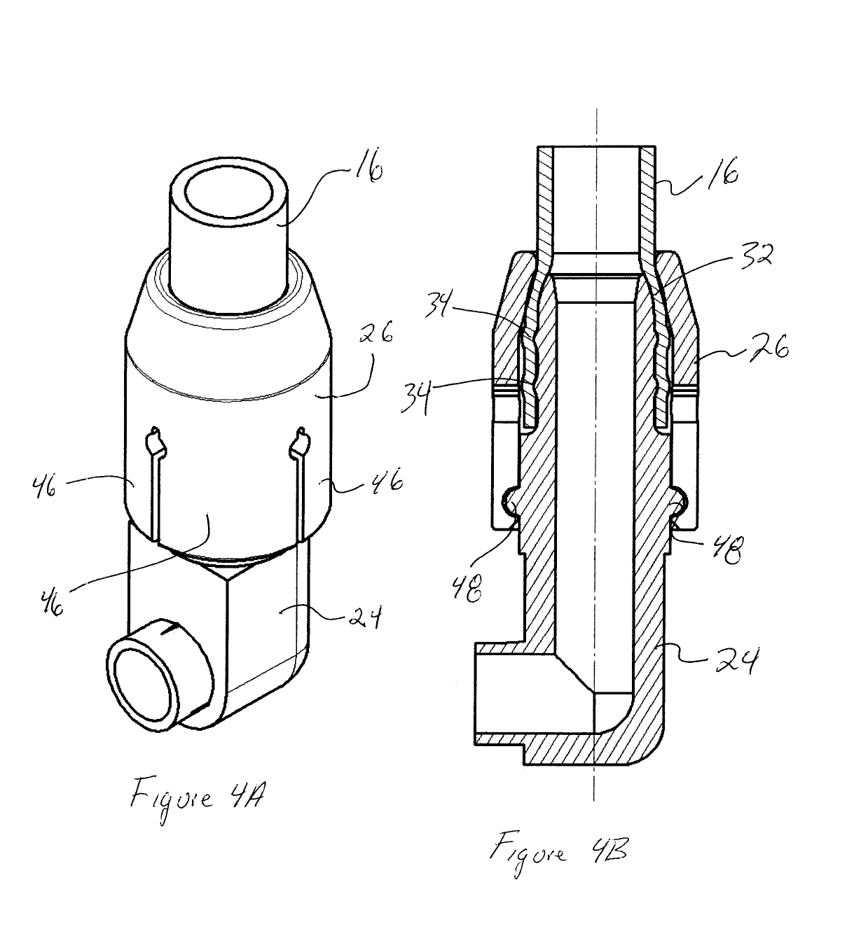

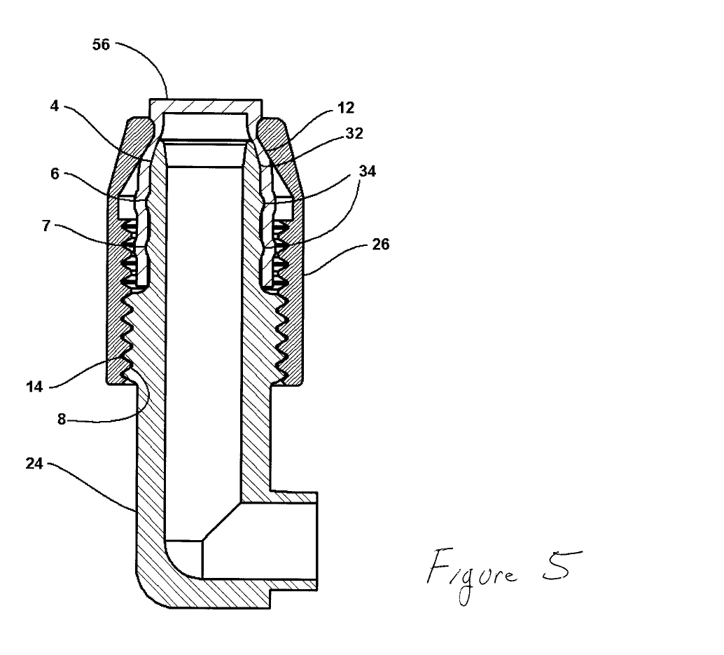

Other ways of releasably engaging tubing receiving structure 24 with retaining mechanism 26 are permitted and can be used with the present invention. Referring to FIGS. 4A and 4B, for example, retaining mechanism 26 includes four quadrants 46 (only three of which are shown). Each of quadrants 46 are flexible enough to expand slightly such that quadrants 46 can pass over ring 48 located on tubing receiving structure 24 until rings 48 seat themselves in recesses 50 located on retaining mechanism 26. First and second fluid seals 32, 34 are created as described above.

Referring to FIG. 5, in an alternative embodiment, a compliant cap 56 can be employed to provide a temporary seal to a fitting. As shown in FIG. 5, compliant cap 56 can be slid over tapered section 4 and rings 6 and 7 of tubing receiving structure 24. The capped end 56 is held in place by the retaining mechanism 26 when retaining mechanism 26 is engaged with receiving structure 24. First and second fluid seals 32 and 34 are produced between compliant cap 56 and tubing receiving structure 24. When used in conjunction with tubing receiving structure 24 and retaining mechanism 26, compliant cap 56 provides a way to close off a connector (not shown) when tubing 16 has been disconnected from the connector. As such, tubing 16 can be removed and the device to which connector 22 is attached can be transported, for example, with fluid in the device while maintaining a clean fluid environment.

The invention has been described in detail with particular reference to certain preferred embodiments thereof, but it will be understood that variations and modifications can be effected within the scope of the invention.

### PARTS LIST

2 longitudinal bore
4 tapered section
6 ring
7 ring
8 threaded section
12 tapered section
14 threaded section
16 tubing
18 redundant fluid seal
20 redundant fluid seal
22 connector
24 tubing receiving structure
26 mechanism
28 exterior surface
30 interior surface
32 fluid seal
34 fluid seal
36 longitudinal bore
38 taper angle
40 taper angle
42 tapered section
44 gap
46 quadrants
48 pins
50 recesses
52 portion
54 portion
56 compliant cap

1. A connector for coupling tubing to another structure, the connector comprising:
a structure for receiving the tubing, the structure including an exterior surface, portions of the exterior surface of the structure defining a tapered section, a threaded section, and at least one ring located between the threaded section and the tapered section;
a mechanism for releasably retaining the tubing over the tubing receiving structure, portions of the mechanism defining a longitudinal bore through which the tubing can be inserted, the mechanism including an interior surface, portions of the interior surface defining a tapered section and a threaded section, wherein when the tubing is positioned over the tapered section and the at least one ring of the tubing receiving structure and the threaded section of the tubing receiving structure is engaged with the threaded section of the retaining mechanism a first fluid seal is present between the tapered section of the tubing receiving structure, the tubing, and the tapered section of the retaining mechanism and a second fluid seal is present between the tubing and the at least one ring of the tubing receiving structure.

2. The connector of claim 1, wherein at least one of the tapered section of the tubing receiving structure and the tapered section of the retaining mechanism includes a portion of a toroid.

3. The connector of claim 2, wherein the tapered section of the retaining mechanism includes a portion of cone.

4. The connector of claim 1, wherein the tapered section of the retaining mechanism includes a portion of cone.

5. The connector of claim 1, wherein the tubing is made from one of a PE, a PP, a PFA, a PTFE, a FEP, and a LLDPE material.

6. The connector of claim 1, wherein the tubing receiving structure is made from a plastic material.

7. The connector of claim 1, wherein the retaining mechanism is made from one of a metal material and a plastic material.

8. The connector of claim 1, wherein portions of the external surface of the tubing receiving structure contactable with the tubing are polished.

9. The connector of claim 1, wherein a gap exists between the internal surface of the retaining mechanism and the tubing when the tubing is positioned over the tapered section and the at least one ring of the tubing receiving structure and the threaded section of the tubing receiving structure is engaged with the threaded section of the mechanism.

10. The connector of claim 1, the tapered section of the tubing receiving structure including a taper angle, the tapered section of the retaining mechanism including a taper angle, wherein the taper angle of the tapered section of the tubing receiving structure is different when compared to the taper angle of the tapered section of the retaining mechanism.

11. The connector of claim 1, wherein the tubing receiving structure includes a longitudinal bore through which fluid can pass.

12. The connector of claim 11, wherein the longitudinal bore of the tubing receiving structure includes a tapered section extending in a direction that is substantially opposite that of the direction in which the tapered section of the tubing receiving structure extends.

13. A connector for coupling tubing comprising:
a structure for receiving the tubing, the structure including an exterior surface, portions of the exterior surface of the structure defining a tapered section and at least one ring;
a mechanism for releasably retaining the tubing over the tubing receiving structure, the retaining mechanism being releasably engagable with the tubing receiving structure, portions of the mechanism defining a longitudinal bore through which the tubing can be inserted, the mechanism including an interior surface, portions of the interior surface defining a tapered section, wherein, when the tubing is positioned over the tapered section and the at least one ring of the tubing receiving structure and the tubing receiving structure is engaged with the retaining mechanism, a first fluid seal is present between the tapered section of the tubing receiving structure, the tubing, and the tapered section of the retaining mechanism and a second fluid seal is present between the tubing and the at least one ring of the tubing receiving structure.

14. The connector of claim 13, wherein the retaining mechanism includes at least one of threads, a clamp, a retaining ring, and a pin such that the retaining mechanism is releasably engagable with the tubing receiving structure.
